(19) United States
(12) Patent Application Publication
(10) Pub. No.: US 2012/0150596 A1
(43) Pub. Date: Jun. 14, 2012

(54) SYSTEMS AND METHODS FOR PROVIDING A SHORT DURATION ADVERTISEMENT WITH MEDIA CONTENT

(76) Inventor: Matthew M. Mclean, Boston, MA (US)

(21) Appl. No.: 13/235,751

(22) Filed: Sep. 19, 2011

Related U.S. Application Data
(60) Provisional application No. 61/384,504, filed on Sep. 20, 2010.

(51) Int. Cl. G06Q 30/02

(52) U.S. Cl. 705/14.4

(57) ABSTRACT

Systems and methods for delivering media content including acquiring the media content and acquiring an advertisement. Then, limiting the advertisement during to less than or equal to about five seconds. The advertisement includes information generally previously known to consumers regarding a product or service. Next, embedding the advertisement into the media content whereby the advertisement is presented after the media content delivery commences and before the media content delivery ends, Then, delivering the media content including the advertisement to one or more portable media devices.

### REFERENCE TO RELATED APPLICATIONS

This application claims priority to and the benefit of U.S. Provisional Patent Application No. 61/384,504, filed on Sep. 20, 2010, and entitled “Short Duration Advertisement for Media Content,” the entire contents of which are incorporated herein by reference.

### FIELD OF THE INVENTION

The invention relates generally to systems and methods for providing media content. More particularly, in various embodiments, the invention relates to providing media content with embedded advertisements to portable media devices.

### BACKGROUND

Media content and advertisement have been commercially available on the Internet and World Wide Web (WWW) for numerous years. As the processing power has increased and become more compact, portable computing devices such as cellular telephones, have developed into powerful multimedia devices capable of displaying videos, playing electronic games, playing music, and capturing video images, among other capabilities. On-line media content providers have developed media content such a videos, images, music, email, blogs, social networking platforms, and other content directed to users of portable media devices. Typically, for a user to access video content at a website, the user is required to view an advertisement before viewing their desired media content. Such advertisements may be 20, 30, or even 60 seconds long. Such a long wait often has an adverse effect on the user's acceptance of the advertised content. Also, the content of the advertisements often include information that promotes or supports a new idea or feature of a product or service that the advertiser intends to promote. Thus, the user may develop a negative impression of the product and advertiser because of the intrusive requirement for the user to view the advertisement before being allowed to view the desired media content. Accordingly, there is a need to enable advertisers to deliver information regarding products or services in a less obtrusive and more user acceptable manner.

### SUMMARY

The invention, in various embodiments, addresses deficiencies in the prior art by providing systems, methods and devices for providing advertising content directing to supporting an existing and generally known position regarding existing products or services and, thus, enable such supporting position to be delivered over a shorter duration and in a less obtrusive manner.

In one aspect, a system for delivering media content includes a media server arranged to: i) acquire the media content, ii) acquire an advertisement, iii) limit the advertisement duration to less than or equal to about five seconds. The advertisement includes information generally previously known to consumers regarding a product or service. The system combines the advertisement with the media content such that the advertisement is embedded within the media content. The advertisement is presented after the media content delivery commences and before the media content delivery ends. The system then send the media content including the advertisement to one or more portable media devices.

In one configuration, the server provides an indication in the media content of the duration of the advertisement. The server may provide an indication in the media content of the period of time when the media content delivery will recommence after delivery of the advertisement. A narrator may provide the indication.

The server may provide a duration indicator in the media content that displays the amount of time remaining for delivery of the media content. The duration indicator may include a countdown timer. The server configure the media content such that the the position of the indicator changes as the countdown timer counts down.

In one configuration, limiting includes confirming that the advertisement duration is less than or equal to about five seconds. The server may remove certain content from the advertisement that includes information that supports new features or ideas related to the product or service, and/or does not support an existing position about the product or service which is generally known to consumers.

In another aspect, a media delivery server includes an input interface that receives media content and an advertisement. The advertisement may include information generally previously known to consumers regarding a product or service. The server also includes a processor arranged to: i) ensure that the advertisement has a duration of less than or equal to about five seconds and ii) combine the media content with the advertisement. The advertisement is embedded within the media content such that the advertisement is presented after the media content delivery commences and before the media content delivery ends. The server includes an output interface that sends the media content including the embedded advertisement to one or more media devices.

### BRIEF DESCRIPTION OF THE DRAWINGS

The foregoing and other objects, features, advantages, and illustrative embodiments of the invention will now be described with reference to the following drawings in which like reference designations refer to the same parts throughout the different views. These drawings are not necessarily to scale, emphasis instead being placed upon illustrating principles of the invention.

FIG. 1A shows the general architecture of a system 100 according to illustrative aspect of the invention.

FIG. 1B shows a time line of an exemplary delivery of media content including a short duration advertisement according to illustrative aspect of the invention.

FIG. 1C illustrates a process of delivering media content including an short duration advertisement according to an illustrative embodiment of the invention.

FIG. 2 includes a functional block diagram of a general purpose computer system

FIG. 3 includes a screen shot of an image of the beginning portion of the video program including an image of news related to Mideast negotiations.

FIG. 4 includes a screen shot of a new caster stating that the news program will be “Coming to you five seconds from now.”

FIG. 5 includes a screen shot of the 5 second ad where the ad is for a particular type of candy bar.

FIG. 6 includes a second screen shot of the 5 second advertisement.

FIG. 7 includes a screen shot of the news caster providing the news program after the 5 second advertisement.

FIG. 8 includes a screen shot of the program with 49 seconds remaining which shows the progression of the counter to the lower middle of the screen.

FIG. 9 includes a screen shot of the program with 10 seconds remaining where the counter is close to the lower right corner of the screen.

FIG. 10 includes a screen shot of the program that is nearly completer where the counter has faded or been removed from the screen within about 3 seconds from the end of the program.

FIG. 11 includes a screen shot of a banner of the program provider “Nubitt” which may be displayed for 1 to about 10 seconds at the end of the program.

### DESCRIPTION

As described above in the summary, the invention is generally related to systems and methods for providing advertisements with media content wherein the advertisement information supports an existing position generally known to consumers and provides such information in a more concise and unobtrusive manner.

Nubitt is the name of a website that can play media content for mobile computers and other electronic media devices. The content may be 90 seconds or less and may be replaced periodically (e.g., daily). The content may be made from still pictures, music stings, music, and recorded talent speaking The pictures may be cropped so that they can be viewed at arms length on a 3-inch screen. In one implementation, a clock displays the remaining time and moves from bottom left to bottom right of the screen. Music stings may be employed to alert the viewer that one story is ending and another is beginning

In one implementation, Nubitt is monetized with one 5-second advertisement that supports an existing position in the consumers mind.

Positions are beliefs consumers have about a product or service. McDonald's owns the “kid friendly, inexpensive, fast food” position. ESPN owns the “TV sports news position” Amstel Light owns the “imported light beer” position. Positions are the one or two words consumers use to identify a product. Who owns the position “corporate rental car”?

Advertisements are asked to do one of two things. Some ads try to develop new positions and other ads support existing positions. There was a time, when television was new, that ads that tried to develop new positions were very effective. The “As Seen on TV” logo was born during a time when just having an ad on television gave a product credibility. That time has pasted. There is evidence now that “new position” ads are counter productive. The younger the viewer the more that viewer is inclined to think a new position is not true.

New positions are not built with advertising. They are built in other ways.

Determining whether an advertisement is trying to build a position or support an existing position is simple. It only takes few seconds to support an existing position. “America runs on Dunkin” re-enforces the belief that Dunkin Donuts customers have about Dunkin Donuts.

Advertisements (Ads) that are longer than a few seconds cause pain. Consider McDonalds egg sandwich. If a consumer doesn't like or appreciate the value of the Egg McMuffin there is no amount of advertising that will change that. In fact, the more Egg McMuffin ads that consumer is exposed to, the more that consumer has his dislike for the product cemented into his head.

The only people who are more irritated by a 15 or 30 second ad for Egg McMuffin are the people who already like the product.

Advertiser supported content is really two distinct transactions. Content is traded for people's attention and that attention is sold to an advertiser. Current business models that allow “new position” ads are not productive for anyone. It's bad for the content maker, content consumer, and advertiser.

An analogy . . . I'm fishing in the harbor and my fishing rod is my content. The fish I catch is people's attention. I sell that fish to the next boat over is like selling to an advertiser. And that advertiser is dumping fuel into the place I am fishing.

In one implementation, a web server provides media content that includes an advertisement to client devices. The client devices may include mobile devices, cellular telephones, smart phones, PDAs, portable computing devices, and the like. As part of delivering certain media content, the server may also deliver a short duration ad. The duration of the ad may be less than about 3 seconds, 5 seconds, 10 seconds, 15 seconds, 20 seconds, 25 seconds, and 30 seconds. The media content may be in the form of a data file, streaming media, and/or a combination. The media content may include certain information such as the news, a movie, a media program, a show, posting, blog, tweet, and the like. The media content may be in the form of a video, audio, and combination thereof. Ads may be provides by companies to the server. The server may decide which ads are suited for which media content. The Nubitt system and/or server may edit and/or streamline certain ads to be short duration ads and then combine one or more ads with a media content for distribution to one or more media devices (e.g., mobile phones).

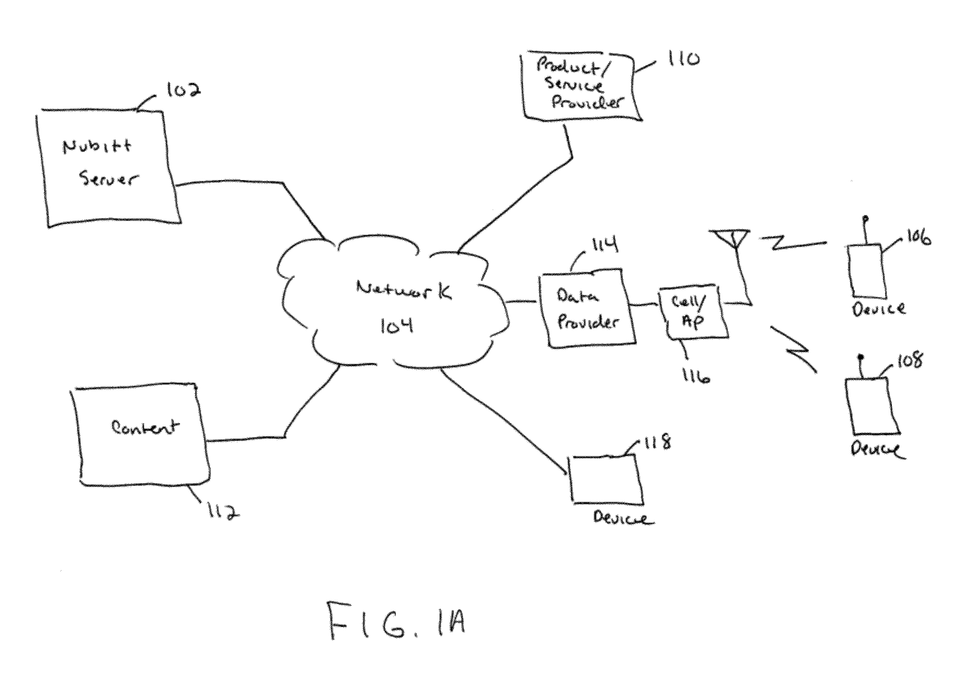

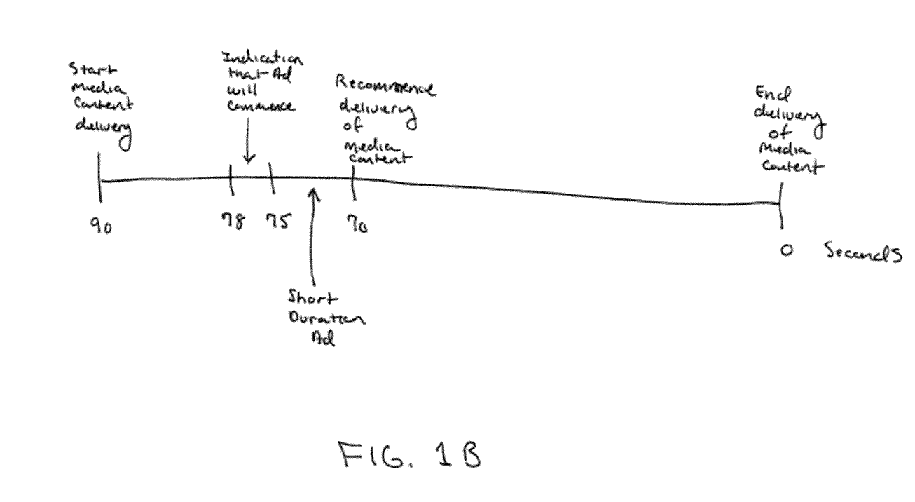

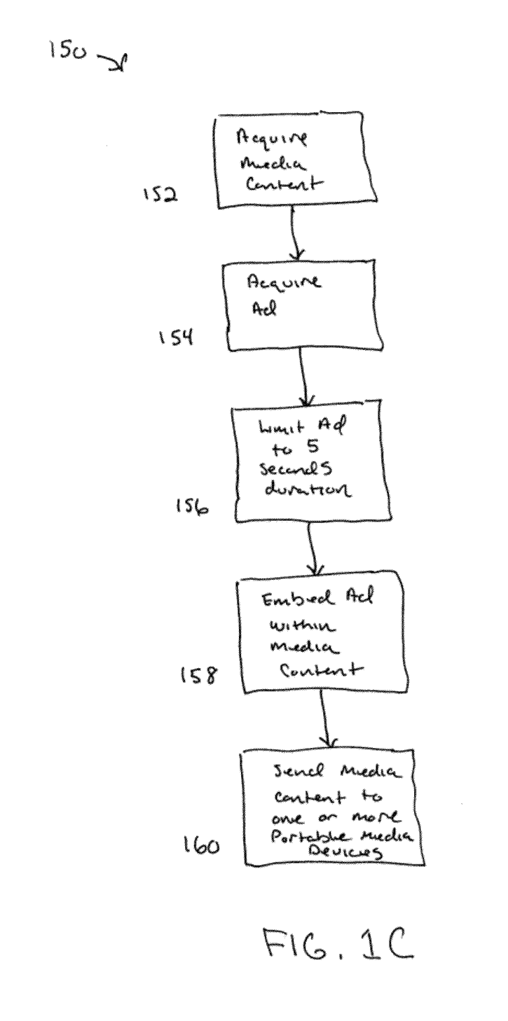

FIG. 1A shows the general architecture of a system 100 according to illustrative aspect of the invention. The system 100 includes a Nubitt Server 102, a network 104 (e.g., the Internet), a product provider server 110, a media content provider server 112, a data provider 114, a base station and/or access point (AP) 116, and media devices 106, 108, and 118. The cell and/or AP may use one of various types of wireless protocols and standards such as time division multiple access (TDMA), code division multiple access (CDMA), 802.11, Wifi, Bluetooth, cellular, GPRS, LTE, EVDO, WiMax, and the like. The media content provider 112 may provide media content to devices and/or to the Nubitt server 102 to enable the server 102 to combine media content with short duration ads. The product provider 110 may be a product provider that provides an ad to the Nubitt server 102 to enable the server 102 to combine the ad content with the media content.

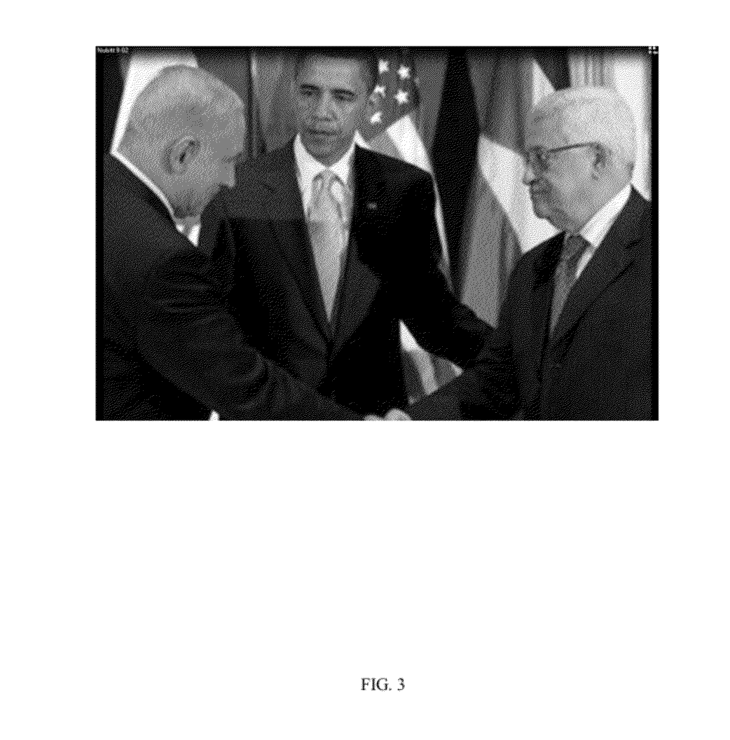

FIG. 1B includes a time line of an exemplary delivery of media content including a short duration advertisement. The exemplary media content has a total duration of about ninety seconds including the advertisement. The media content delivery is also illustrated in FIGS. 3-11. The media content includes a narrator that provides an indication (starting at about 78 seconds) that the media content delivery will recommence in about five seconds. Additionally or alternatively, the indication may indicate that the advertisement is about to commence. After the advertisement is displayed for about five seconds, the media content delivery recommences. The media content display may include a displayed timer which may move from left to right across the display video image as the timer counts down to the end of the media content delivery.

FIG. 1C illustrates a process 150 of delivering media content including a short duration advertisement according to an illustrative embodiment of the invention. In one implementation, a server (e.g., server 102 of FIG. 1) acquires media content. (Step 152). The server may acquire and store a plurality of media content of different types or forms such as, without limitation, video, audio, music, multimedia, images, and the like. The server acquires an advertisement. (Step 154). The server may acquire a plurality of advertisements of different forms such as video, audio, and the like. The server then limits the duration of the advertisement to less than or equal to about 5 seconds. (Step 156). Limiting may include confirming the advertisement during is less than or equal to about 5 seconds. If the duration is longer, limiting may include redacting the duration to less than or equal to about 5 seconds. The advertisement information may be limited to only content that supports an existing position about a product or service known generally by consumers. The server embeds the advertisement within the media content such that the advertisement is included in the media content after the media content delivery commences and before the media content delivery end. (Step 158). Then, the server sends the media content with embedded advertisement to one or media devices. (Step 160).

The media content may include a news clip, informational video, game, story, movie, show, and the like. The media content may be in the form of video, audio, and/or a combination thereof. The media content may include a digital and/or analog format.

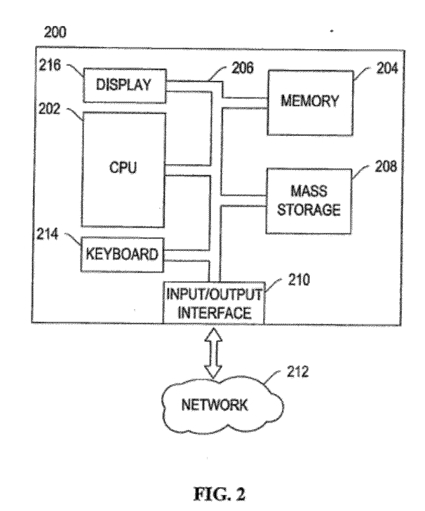

FIG. 2 includes a functional block diagram of a general purpose computer system, e.g., Nubitt server 102 of FIG. 1, according to an illustrative embodiment of the invention. The exemplary computer system 200 includes a central processing unit (CPU) 202, a memory 204, and an interconnect bus 206. The CPU 202 may include a single microprocessor or a plurality of microprocessors for configuring computer system 200 as a multi-processor system. The memory 204 illustratively includes a main memory and a read only memory. The computer 200 also includes the mass storage device 208 having, for example, various disk drives, tape drives, etc. The main memory 204 also includes dynamic random access memory (DRAM) and high-speed cache memory. In operation, the main memory 204 stores at least portions of instructions and data for execution by the CPU 202.

The mass storage 208 may include one or more magnetic disk or tape drives or optical disk drives or solid state memories or memory sticks, for storing data and instructions for use by the CPU 202. At least one component of the mass storage system 208, preferably in the form of a disk drive or tape drive, stores the database used for processing data and/or patient physiological data of the system 100. The mass storage system 208 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 200. The storage system 208 may store patient related physiological data for multiple patents over a period of time to enable the system 200 (or central station 128) to analyze the patient data, generate metadata or trend data and charts, and/or to present selected portions of data to users or distribute selected portions of data to devices 134 and 136.

The computer system 200 may also include one or more input/output interfaces for communications, shown by way of example, as interface 210 for data communications via the network 212 (or network 114). The data interface 210 may be a modem, an Ethernet card or any other suitable data communications device. To provide the functions of a computer 102 according to FIG. 1, the data interface 210 may provide a relatively high-speed link to a network 212 (or network 104 of FIG. 1), such as an intranet, internet, or the Internet, either directly or through an another external interface 116. The communication link to the network 212 may be, for example, optical, wired, or wireless (e.g., via satellite or cellular network). Alternatively, the computer system 200 may include a mainframe or other type of host computer system capable of Web-based communications via the network 212. The computer system 200 may include software for operating an network application such as a web server and/or web client.

The computer system 200 also includes suitable input/output ports or use the interconnect bus 206 for interconnection with a local display 216 and keyboard 214 or the like serving as a local user interface for programming and/or data retrieval purposes. The display 216 may include a touch screen capability to enable users to interface with the system 200 by touching portions of the surface of the display 216. The display 216 may enable a graphical display on one or more patient physiological parameters associated with one or more patients and/or patient monitors. Server operations personnel may interact with the system 200 for controlling and/or programming the system from remote terminal devices via the network 212.

The computer system 200 may run a variety of application programs and store associated data in a database of mass storage system 208. One or more such applications may enable the receipt and delivery of messages to enable operation as a server, for implementing server functions relating to distributing media content including short duration ads to devices 106 and 108 of FIG. 1.

The components contained in the computer system 200 are those typically found in general purpose computer systems used as servers, workstations, personal computers, network terminals, and the like. In fact, these components are intended to represent a broad category of such computer components that are well known in the art.

As discussed above, the general purpose computer system 200 may include one or more applications that provide patient management and information collection and distribution in accordance with features of the invention. The system 200 may include software and/or hardware that implements a web server application. The web server application may include software such as HTML, XML, WML, SGML, PHP (Hypertext Preprocessor), CGI, and like languages.

The foregoing features may be realized as a software component operating in the system 200 where the system 200 is Unix workstation or other type of workstation. Other operation systems may be employed such as, without limitation, Windows, MAC OS, and LINUX. In some embodiments, the monitor, central station, or device software can optionally be implemented as a C language computer program, or a computer program written in any high level language including, without limitation, C++, Fortran, Java, or Visual BASIC. Certain script-based programs may be employed such as XML, WML, PHP, and so on. Additionally, general techniques for high level programming are known, and set forth in, for example, Stephen G. Kochan, Programming in C, Hayden Publishing (1983). The system 200 may use a DSP for which programming principles well known in the art.

As stated previously, the mass storage 208 may include a database. The database may be any suitable database system, including the commercially available Microsoft Access database, and can be a local or distributed database system. The design and development of suitable database systems are described in McGovern et al., A Guide To Sybase and SQL Server, Addison-Wesley (1993). The database can be supported by any suitable persistent data memory, such as a hard disk drive, RAID system, tape drive system, floppy diskette, or any other suitable system. The system 200 may include a database that is integrated with the system 200, however, it will be understood by those of ordinary skill in the art that in other implementations the database and mass storage 208 can be an external element.

In certain embodiments, the system 200 may include an Internet browser program and/or be configured operate as a web server. In some embodiments, the client and/or web server may be configured to recognize and interpret various network protocols that may be used by a client or server program. Commonly used protocols include Hypertext Transfer Protocol (HTTP), File Transfer Protocol (FTP), Telnet, and Secure Sockets Layer (SSL), for example. However, new protocols and revisions of existing protocols may be frequently introduced. Thus, in order to support a new or revised protocol, a new revision of the server and/or client application may be continuously developed and released.

In one implementation, the system 100 includes a networked-based, e.g., Internet-based, application that may be configured and run on a device 134 and/or any combination of the other components of the system 100. The system 100 (or central station 128 or monitor 102) may include a web server running a Web 2.0 application or the like. The devices 106 and 108 may include web clients. Web applications running on the system 100 may use server-side dynamic content generation mechanisms such, without limitation, Java servlets, CGI, PHP, or ASP. In certain embodiments, mashed content may be generated by a web browser via, for example, client-side scripting including, without limitation, JavaScript and/or applets.

In certain embodiments, the server 102 may include applications that employ asynchronous JavaScript+XML (Ajax) and like technologies that use asynchronous loading and content presentation techniques. These techniques may include, without limitation, XHTML and CSS for style presentation, document object model (DOM) API exposed by a web browser, asynchronous data exchange of XML data, and web browser side scripting, e.g., JavaScript. Certain web-based applications and services may utilize web protocols including, without limitation, the services-orientated access protocol (SOAP) and representational state transfer (REST). REST may utilize HTTP with XML.

The devices 106 and 108, sever 102, and/or other components of system 100 may also provide enhanced security and data encryption. Enhanced security may include access control, biometric authentication, cryptographic authentication, message integrity checking, encryption, digital rights management services, and/or other like security services. The security may include protocols such as IPSEC and IKE. The encryption may include, without limitation, DES, AES, RSA, and any like public key or private key based schemes.

FIGS. 3-11 provide an exemplary set of screen shots of a streaming (and/or video file) program and/or video clip that is broadcast to a device such as a mobile smartphone or other portable media device. The media program includes a news program having a short duration advertisement for a candy (e.g., about 5 seconds in duration).

FIG. 3 includes a screen shot of an image of the beginning portion of the video program including an image of news related to Mideast negotiations.

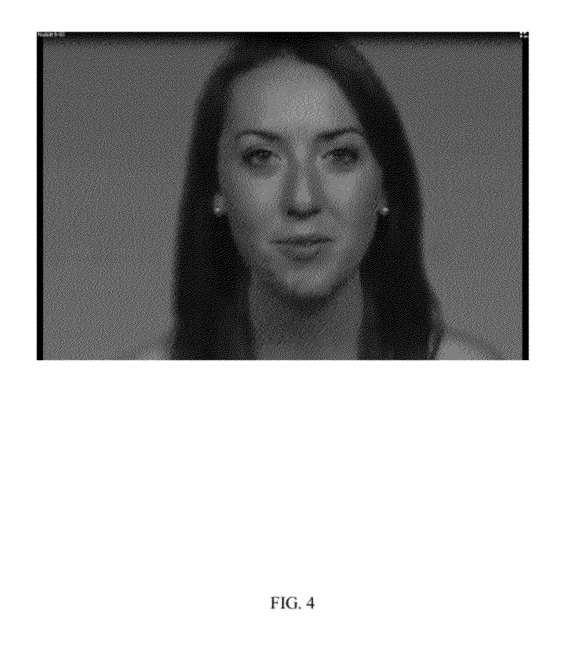

FIG. 4 includes a screen shot of a new caster stating that the news program will be “Coming to you five seconds from now.”

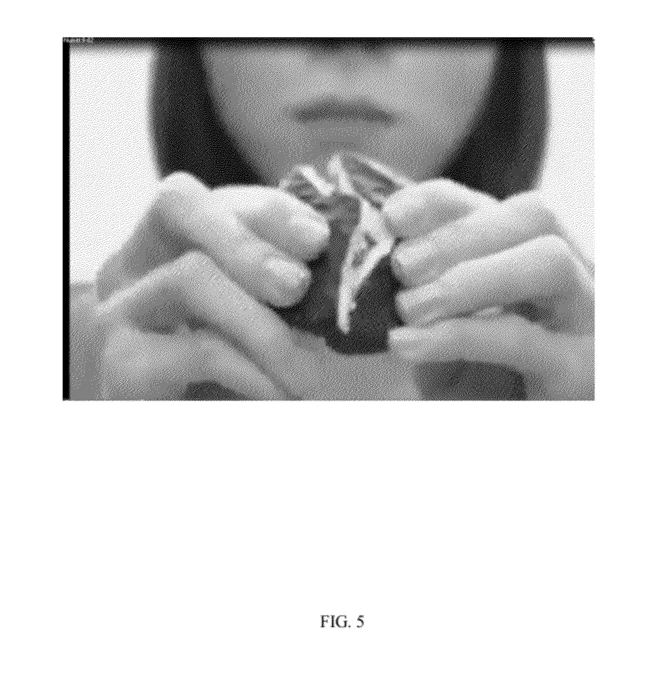

FIG. 5 includes a screen shot of the 5 second ad where the ad is for a particular type of candy bar.

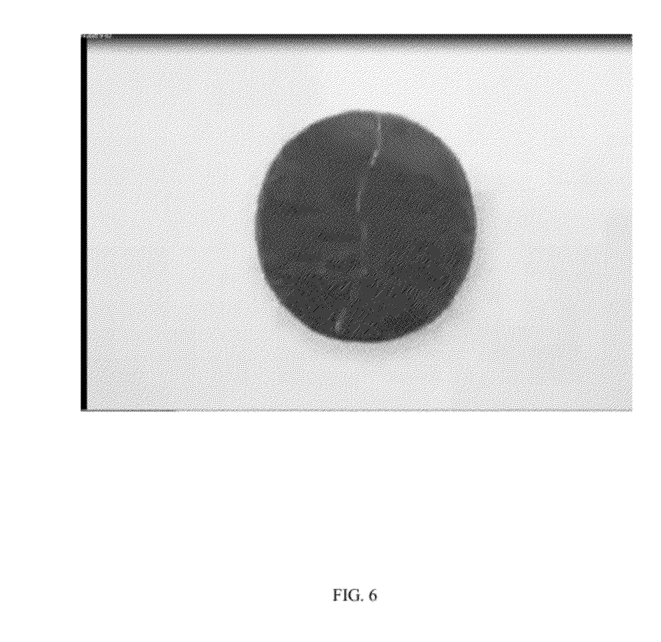

FIG. 6 includes a second screen shot of the 5 second ad.

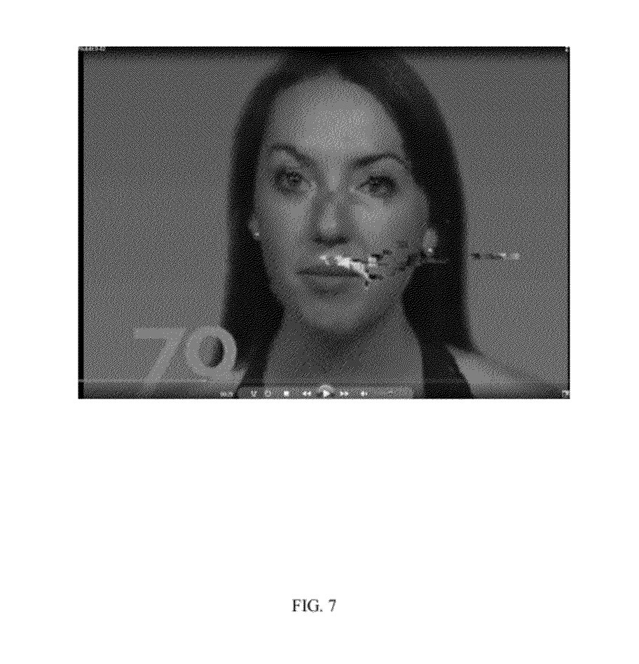

FIG. 7 includes a screen shot of the news caster providing the news program after the 5 second ad. The screen shows that there are 79 seconds left in the program. The time is displayed in the lower left corner and gradually moves from left to right as the number counts down and the remaining duration of the program becomes less. The count down number may move up, down, left to right, right to left, diagonally, and in any other direction as the program progress. The counter may increase or decrease in size, change color, become more or less transparent. The counter may include a corresponding sound, volume, pitch, frequency, tone, and the like as it counts down.

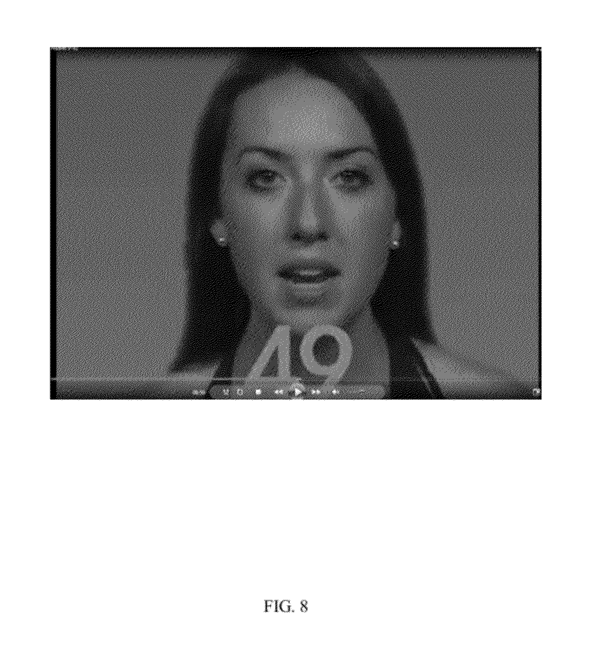

FIG. 8 includes a screen shot of the program with 49 seconds remaining which shows the progression of the counter to the lower middle of the screen.

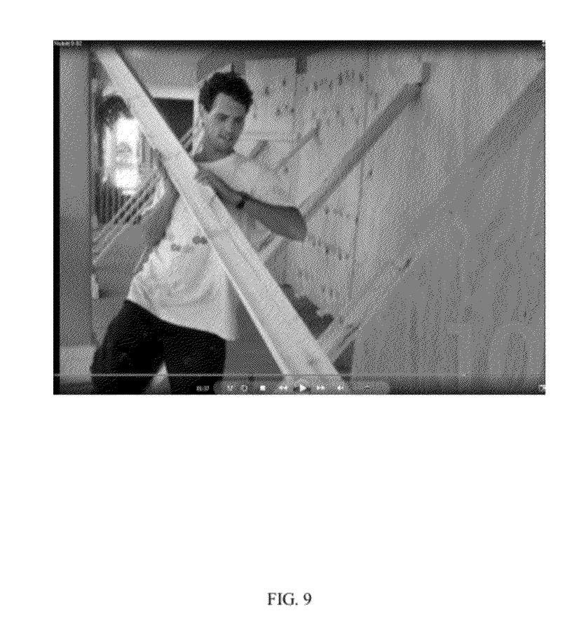

FIG. 9 includes a screen shot of the program with 10 seconds remaining where the counter is close to the lower right corner of the screen.

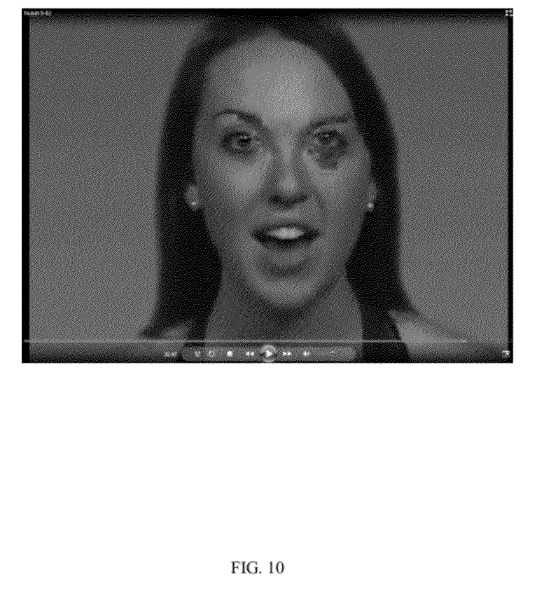

FIG. 10 includes a screen shot of the program that is nearly completer where the counter has faded or been removed from the screen within about 3 seconds from the end of the program.

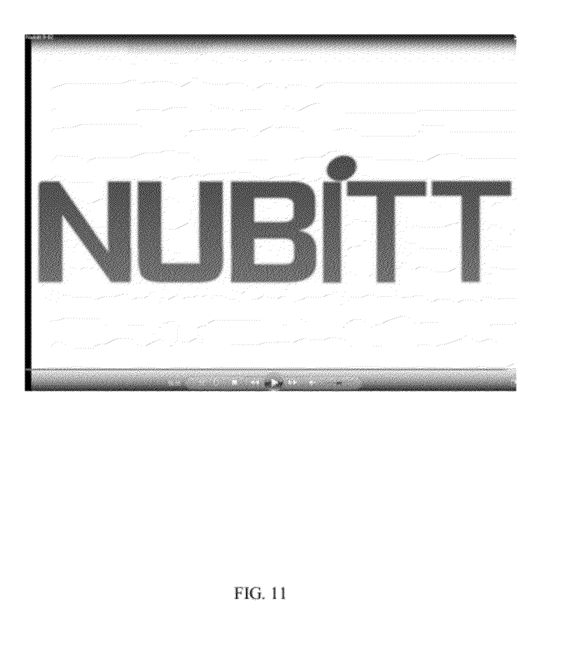

FIG. 11 includes a screen shot of a banner of the program provider “Nubitt” which may be displayed for 1 to about 10 seconds at the end of the program.

It will be apparent to those of ordinary skill in the art that methods involved in the present invention may be embodied in a computer program product that includes a computer usable and/or readable medium. For example, such a computer usable medium may consist of a read only memory device, such as a CD ROM disk, conventional ROM devices, or a random access memory, a hard drive device or a computer diskette, a flash memory, a DVD, or any like digital memory medium, having a computer readable program code stored thereon.

Persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods, systems and apparatuses, but is intended to include variations to and modifications thereof as understood by those skilled in the art with respect to the following claims.

What is claimed is:

1. A method for delivering media content comprising:
acquiring the media content;
acquiring an advertisement and limiting the advertisement during to less than or equal to about five seconds, the advertisement including information generally previously known to consumers regarding a product or service;
embedding the advertisement into the media content whereby the advertisement is presented after the media content delivery commences and before the media content delivery ends; and
delivering the media content including the advertisement to one or more portable media devices.

2. The method of claim 1 comprising providing an indication in the media content of the duration of the advertisement.

3. The method of claim 1 comprising providing an indication in the media content of the period of time when the media content delivery will recommence after delivery of the advertisement.

4. The method of claim 3, wherein a narrator provides the indication.

5. The method of claim 1 comprising providing a duration indicator in the media content that displays the amount of time remaining for delivery of the media content.

6. The method of claim 5, wherein the duration indicator includes a countdown timer.

7. The method of claim 6 comprising changing the position of the indicator as the countdown timer counts down.

8. The method of claim 1, wherein limiting includes confirming that the advertisement duration is less than or equal to about five seconds.

9. The method of claim 8 comprising removing content from the advertisement that includes information that supports new features or ideas related to the product or service.

10. A system for delivering media content comprising:
a media server arranged to: i) acquire the media content, ii) acquire an advertisement, iii) limit the advertisement duration to less than or equal to about five seconds, the advertisement including information generally previously known to consumers regarding a product or service, iv) combine the advertisement with the media content, the advertisement being embedded within the media content whereby the advertisement is presented after the media content delivery commences and before the media content delivery ends, and v) send the media content including the advertisement to one or more portable media devices.

11. The system of claim 10, wherein the server provides an indication in the media content of the duration of the advertisement.

12. The system of claim 10, wherein the server provides an indication in the media content of the period of time when the media content delivery will recommence after delivery of the advertisement.

13. The system of claim 12, wherein a narrator provides the indication.

14. The system of claim 10, wherein the server provides a duration indicator in the media content that displays the amount of time remaining for delivery of the media content.

15. The system of claim 14, wherein the duration indicator includes a countdown timer.

16. The system of claim 15, wherein the server changes the position of the indicator as the countdown timer counts down.

17. The system of claim 10, wherein limiting includes confirming that the advertisement duration is less than or equal to about five seconds.

18. The system of claim 17, wherein the server removes content from the advertisement that includes information that supports new features or ideas related to the product or service.

19. A media delivery server comprising:
an input interface arranged to receive media content and an advertisement, the advertisement including information generally previously known to consumers regarding a product or service;
a processor arranged to: i) ensure that the advertisement has a duration of less than or equal to about five seconds and ii) combine the media content with the advertisement, the advertisement being embedded within the media content whereby the advertisement is presented after the media content delivery commences and before the media content delivery ends;
an output interface arranged to send the media content including the embedded advertisement to one or more media devices.

20. The server of claim 19, wherein the processor embeds an indication in the media content of at least one of i) the duration of the advertisement and ii) the period of time when the media content delivery will recommence after delivery of the advertisement.
